(19) United States
(12) Patent Application Publication
(10) Pub. No.: US 2002/0074857 A1
(43) Pub. Date: Jun. 20, 2002

(54) Digital anti-lock wheel speed sensor

(76) Inventors: John Babico, Tucson, AZ (US); Pierre Abboud, Suwanee, GA (US)

Correspondence Address: CALFEE HALTER & GRISWOLD, LLP, 800 SUPERIOR AVENUE, SUITE 1400, CLEVELAND, OH, 44114, US

(21) Appl. No.: 09/973,258

(22) Filed: Oct. 9, 2001

Related U.S. Application Data
(63) Continuation-in-part of application No. 09/635,185, filed on Aug. 8, 2000, now abandoned.

(51) Int. Cl. B60T 8/78

(52) U.S. Cl. 303/199

(57) ABSTRACT

An anti-lock braking system includes a speed sensor and a central processing unit (“CPU”). The speed sensor includes a motion sensor, an integral processing unit (“IPU”), and a housing which surrounds the motion sensor and the IPU. The motion sensor produces an analog signal as a function of a movement of an object, and the IPU converts the analog signal to a digital signal within the speed sensor. The IPU of the speed sensor transmits the digital signal to the CPU as a function of the analog signal received from the motion sensor. The CPU achieves an anti-lock braking action of the object as a function of the digital signal received from the IPU of the speed sensor.

### CROSS-REFERENCE TO RELATED APPLICATION

This application is a Continuation-in-Part application of U.S. patent application Ser. No. 09/635,185 filed on Aug. 8, 2001 and entitled “Digital Anti-Lock Speed Sensor.

### FIELD OF THE INVENTION

The present invention relates to an anti-lock wheel speed sensor for an electrically controlled anti-lock braking systems. More specifically, an anti-lock wheel speed sensor includes an integral processing unit which converts an analog wheel speed signal into a digital wheel speed signal.

### BACKGROUND OF THE INVENTION

The present invention relates to mechanisms for electrically controlled braking systems (“EBS”). It finds particular application in conjunction with an anti-lock braking system (“ABS”) and will be described with particular reference thereto. It will be appreciated, however, that the invention is also amenable to other like applications.

Vehicles equipped with a conventional EBS or ABS typically include a central processing unit (“CPU”) that is electrically connected to wheel speed sensors, which are located on each wheel of the vehicle. During a time while the vehicle is braking, the wheel speed sensors measure a rotational motion of the respective wheels. More specifically, each sensor is fixed relative to a tone-wheel, which is located on an axle of the respective wheel. Ferro-magnetic protrusions extend from each of the tone-wheels. The protrusions pass by the respective sensors as each of the wheels and, consequently, the tone-wheels rotate. The frequency at which the protrusions pass each of the sensors is a function of the rotational speed of the respective wheel. Each sensor generates an analog signal having frequency and amplitude components that are both functions of the frequency at which the protrusions pass the sensor. More specifically, both the frequency and the amplitude of the analog signal increases/decreases in proportion to the rotational speed of a wheel.

Each of the analog signals is continuously transmitted from the respective sensors to the CPU. The CPU generates digital data in accordance with the incoming analog signal. Then, the CPU determines the rotational speed of each of the wheels based upon the digital data. An average speed of the vehicle is calculated as a function of the rotational speed of each of the wheels. To determine if any of the wheels is slipping, the CPU compares the rotational speed of each of the wheels with the average speed of the vehicle. More specifically, if a deceleration of a wheel is outside a predetermined range, it is determined that wheel is slipping. The CPU then modulates the brakes in any of the wheels that is slipping until the speed of the respective wheel is within the predetermined tolerance of the average speed of the vehicle. This process is repeated continuously while the vehicle is braking.

The analog signals transmitted between the sensors and the CPU are susceptible to noise (e.g., electromagnetic interference), especially when the vehicle is traveling at relatively low speeds. Attempts to reduce this noise have involved electrically connecting the sensors to the CPU using twisted-pair wires and/or shielded cables. Furthermore, signal conditioning circuits and/or filters, etc. have been incorporated into the CPU for “cleaning-up” the incoming signals before generating the corresponding digital data. While these techniques have improved the performance of ABS's at low speeds, they also require relatively more complex and expensive components and result in increased manufacturing costs. Furthermore, these conventional ABS's are only capable of reliably deciphering analog signals generated when the vehicle is moving at speeds of about four (4) miles per hour (“mph”) or greater.

U.S. Pat. Nos. 5,406,485 and 5,352,938 disclose conventional analog to digital signal conversion circuits for ABS. The analog signal is transmitted from the wheel speed sensors to the signal conversion circuits. Due to the degradation of the analog signal which occurs between the wheel speed sensors and the circuits, conventional signal conversion circuits must process the analog wheel speed signal through amplifier and comparator circuits prior to converting the analog signal into a digital signal.

It would be advantageous to avoid signal degradation by mounting a signal conversion circuit within a wheel speed sensor. However, conventional signal conversion circuits utilize components which have a maximum temperature rating of only about 150 degrees centigrade. During operation the temperature of the brakes may be as high as 180 degrees centigrade. Since the wheel speed sensors are installed in close proximity to the brakes, they are heated by the brakes. Conventional circuits must be mounted at a location which is separate from the brakes, because they do not have sufficient heat resistance to be mounted within wheel speed sensors.

It would therefore be desirable to provide a wheel speed sensor which converts an analog wheel speed signal into a digital wheel speed signal within the wheel speed sensor. It would also be desirable to provide a wheel speed sensor which transmits a digital wheel speed signal to the CPU, provides a reliable signal at vehicle speeds less than about four (4) mph, provides a reliable signal at high temperatures, and reduces manufacturing costs by utilizing less complicated and less expensive components.

### SUMMARY OF THE INVENTION

An anti-lock braking system includes a speed sensor and a CPU. The speed sensor includes a motion sensor, an integral processing unit (“IPU”), and a housing which surrounds the motion sensor and the IPU. The motion sensor produces an analog signal as a function of a movement of an object, and the IPU converts the analog signal to a digital signal within the speed sensor. The IPU of the speed sensor transmits the digital signal to the CPU as a function of the analog signal received from the motion sensor. The CPU achieves an anti-lock braking action of the object as a function of the digital signal received from the IPU of the speed sensor.

In accordance with one aspect of the invention, the anti-lock braking system includes: a CPU; and a speed sensor which is composed of a motion sensor, an IPU, and a housing which surrounds the motion sensor and the IPU. The motion sensor produces an analog signal as a function of a movement of an object. The IPU electrically communicates with the CPU and the motion sensor The IPU transmits a digital signal to the CPU as a function of the analog signal received from the motion sensor. The CPU achieves an anti-lock braking action of the object as a function of the digital signal received from the IPU. The IPU includes: first and second inputs electrically communicating with the motion sensor; first and second outputs electrically communicating with the CPU; and a plurality of primary switching means set as a function of the analog signal received by the electrical inputs from the motion sensor. Current passes through the plurality of the primary switching means if the analog signal inputs receive from the motion sensor is one of less than and equal to a predetermined amplitude, thereby creating a logical high at the outputs.

In accordance with a further aspect of the invention, the IPU includes a charge control device. Current passes through the additional switching means as a function of the analog signal received from the motion sensor A power capacitor is one of charged and discharged as a function of whether current is passing through the additional switching means. The power capacitor supplies power to the IPU when discharging.

In accordance with a still further aspect of the invention, the IPU includes a second capacitor and a diode. The second capacitor and the diode are electrically connected in parallel between the inputs and act to clip negative signal inputs from the inputs.

In accordance with another aspect of the invention, the IPU includes a resistive means. One of the primary switching means and the resistive means is electrically connected in series, and then the series connected components are connected in parallel with the inputs to provide compensation for temperature changes.

In accordance with another aspect of the invention, the primary switching means, the additional switching means, the power capacitor, the second capacitor, the diode, and the resistive means are included on a single circuit chip.

In accordance with still another aspect of the invention, the object is a wheel.

In accordance with another aspect of the invention, the motion sensor is a magnetic pick-up coil.

In accordance with another aspect of the invention, a plurality of resistive means provide a testing mechanism for at least one of the IPU and the motion sensor.

In accordance with another aspect of the invention, a plurality of additional motion sensors and additional IPU's transmit signals to the CPU corresponding to movements of a plurality of additional respective objects. The CPU transmits independent braking signals to activate respective braking devices corresponding to the objects for achieving respective anti-lock braking actions.

In accordance with another aspect of the invention the IPU is composed of components which function in a high temperature environment which is greater than or equal to 180 degrees centigrade.

In accordance with another aspect of the invention the other ones of the primary switching means are electrically connected in parallel between the outputs.

In accordance with a further aspect of the invention a resistor is electrically connected between the outputs. The primary switching means are electrically connected in parallel between the outputs, and one of the primary switching means, a diode, and another on of the primary switching means are electrically connected in series.

One advantage of the present invention is that it provides a wheel speed sensor which includes a motion sensor and an IPU that converts an analog wheel speed signal into a digital wheel speed signal, and signal conversion occurs within the wheel speed sensor. Another advantage of the present invention is that the wheel speed sensor transmits a digital wheel speed signal to the CPU, provides a reliable signal at vehicle speeds less than about four (4) mph, provides a reliable signal at high temperatures, and reduces manufacturing costs by utilizing less complicated and less expensive components.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

The invention will be described in greater detail with reference to the following detailed description of the preferred embodiments of the invention along with the accompanying drawings, wherein:

FIG. 1 illustrates a bottom view of a vehicle including an anti-lock braking system according to the present invention,

FIG. 2 illustrates an electrical schematic of a circuit which includes the CPU and the IPU;

FIG. 3 illustrates a physical layout of the IPU of the present invention illustrated in FIG. 2;

FIG. 4 illustrates a second embodiment of the present invention;

FIG. 5 illustrates a wheel speed sensor which includes a motion sensor and an IPU which converts an analog wheel speed signal into a digital wheel speed signal; and

FIG. 6 is a cross-sectional view of the wheel speed sensor of FIG. 5.

### DETAILED DESCRIPTION OF THE PREFERRED EMBODIMENTS

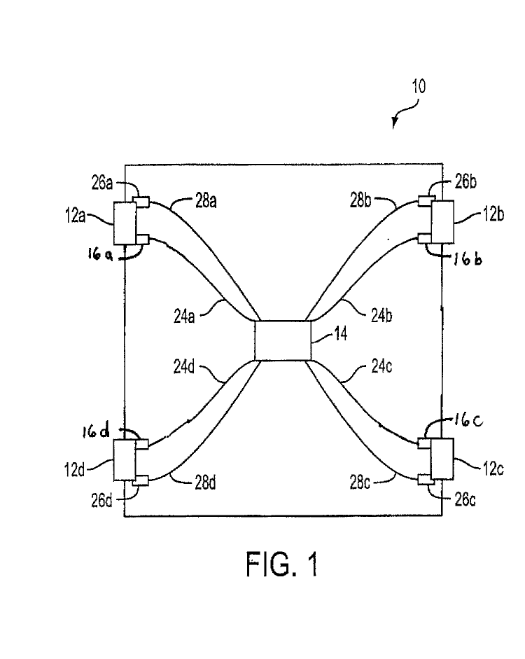

FIG. 1 illustrates a bottom view of a vehicle 10 including four (4) wheels 12a, 12b, 12c, and 12d (12) and an EBS or ABS. The system preferably includes a CPU 14 and wheel speed sensors 16a, 16b, 16c, and 16d (16) The number of wheel speed sensors 16 is preferably equal to the number of wheels (i.e., four(4) in the illustrated embodiment). The wheel speed sensors 16a, 16b, 16c, 16d receive analog signals and output digital signals to the CPU 14 via respective electrically conductive connectors 24a, 24b, 24c, and 24d (24). The CPU 14 controls respective braking devices 26a, 26b, 26c, and 26d (26) via electrically conductive connectors 28a, 28b, 28c, and 28d (28) to achieve an anti-lock braking action.

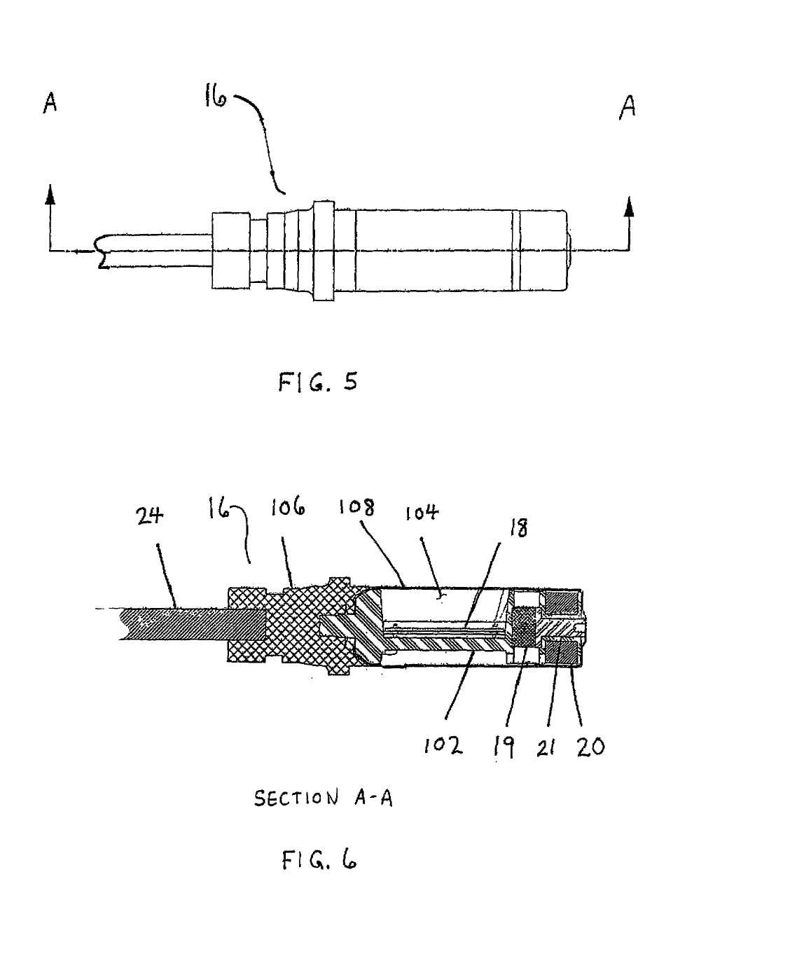

FIGS. 5 and 6 illustrate a wheel speed sensor 16 in accordance with a preferred embodiment of the invention. The wheel speed sensor 16 includes an integral processing unit (“IPU”) 18, a motion sensor 20, a conductive connector 24, a bobbin overmold 102, an encapsulating material 104, a housing overmold 106, and a housing 108. The a bobbin overmold 102 supports the IPU 18. The working components, the IPU 18 and the motion sensor 20, are protected by the encapsulating material 104, the housing overmold 106, and the housing 108. The motion sensor 20 is preferably a magnetic pickup coil such as a variable reluctance coil which further includes a magnet 19 and a bobbin 21. The motion sensor 20 is utilized for monitoring a rotational speed of each of the respective wheels 12.

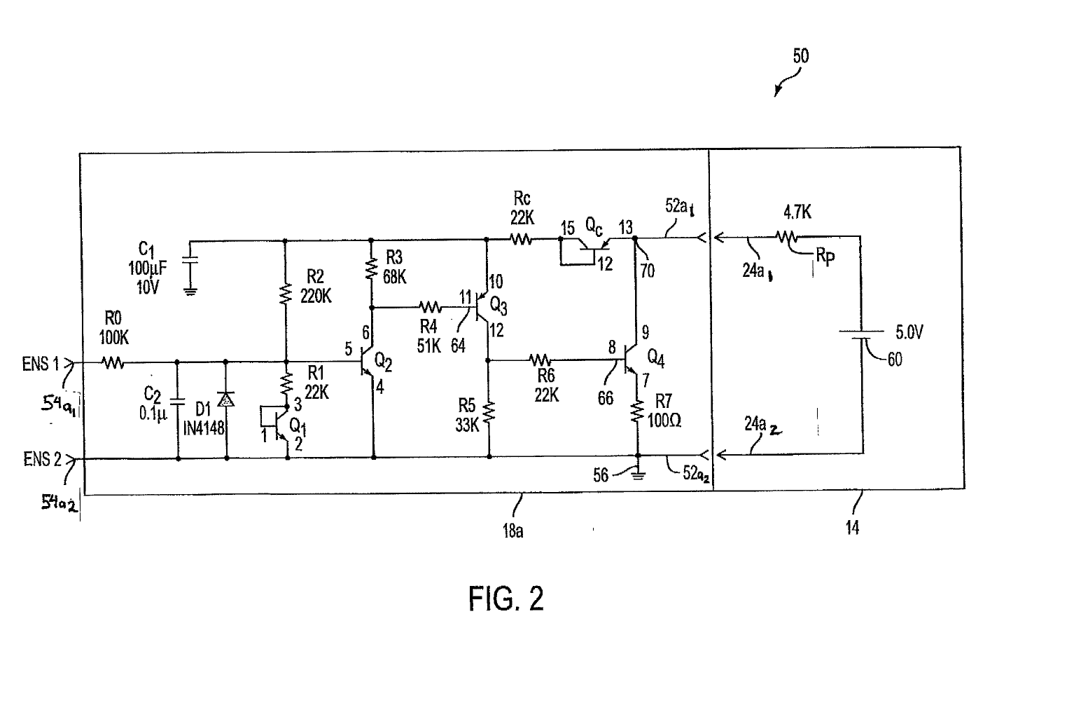

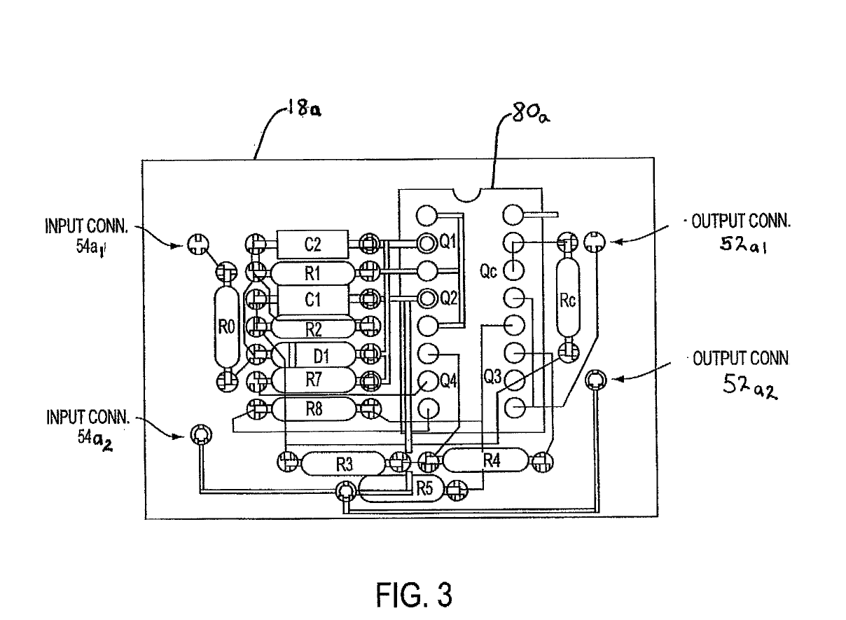

FIG. 2 illustrates an electrical schematic of a circuit 50 including the CPU 14 and the IPU 18a. Although the circuit 50 shown in FIG. 2 includes IPU 18a, it is to be understood that each of the other IPUs 18b, 18c, 18d includes a similar circuit. FIG. 3 illustrates a physical layout of the IPU 18a of the present invention illustrated in FIG. 2.

With reference to FIGS. 2 and 3, an output of the IPU 18a is electrically connected to the CPU via first and second output terminals 52a₁ and 52a₂, which are electrically connected to the conductive connectors 24a₁ and 24a₂. First and second input terminals 54a₁ and 54a₂ of the circuit 50 are electrically connected to a respective one of the motion sensors 20. The second input terminal 54a₂ is electrically connected to a ground 56. When a respective wheel 12 moves, an analog electrical pulse is created in its respective motion sensor 20. Each time Ferro-magnetic teeth (not shown) on the respective wheel 12 of the vehicle pass the motion sensor 20, the analog electrical pulse is sent to the input terminals 54a₁ and 54a₂. The rate at which the Ferro-magnetic teeth pass the motion sensor 20 is proportional to the rotational speed of the wheel. A voltage and amplitude of the analog electrical pulse on the input terminals 54a₁ and 54a₂ corresponds to the rate at which the Ferro-magnetic teeth pass the motion sensor 20.

The operation of the circuit 50 shown on FIG. 2 is described as follows. When an analog signal larger than a predetermined amplitude is created on the input terminals 54a₁ and 54a₂, first and second primary transistors Q1, Q2 are switched to an “on” state. Consequently, current from a power source 60 in the CPU 14 flows through first and second resistors R1, R2 via a resistor R_{P} in the CPU 14. As will be described in more detail below, the current flows through the circuit 50 via a charging transistor Q_{C} and a charging resistor R_{C}.

Once the second transistor Q2 turns on, current flows through third and fourth resistors R3, R4. As a result, a base input 64 to a third primary transistor Q3 is set to a logical low and the third transistor Q3 turns on. When the third transistor Q3 turns on, current flows through fifth and sixth resistors R5, R6, respectively, thereby providing a logical high signal to a base input 66 of a fourth primary transistor Q4. Therefore, the fourth transistor Q4 turns on. When the fourth transistor Q4 turns on, current flows through a seventh resistor R7 and a logical low appears at a point 70 of the circuit 50. Therefore, a logical low signal is output to the CPU 14 when the Ferro-magnetic teeth on the wheel of the vehicle pass by the motion sensor 20.

When a signal less than or equal to the predetermined amplitude is created on the input terminals 54a₁ and 54a₂, the first and second transistors Q1, Q2 are switched to an “off” state. Consequently, no current flows through the first and second resistors R1, R2. When the second transistor Q2 turns off, the base input 64 to the third transistor Q3 is electrically connected to the power source 60 via the third and fourth resistors R3, R4, the charging resistor R_{C}, and the charging transistor Q_{C}. Therefore, because the base input to the third transistor Q3 is a logical high, the third transistor Q3 turns off. When the third transistor Q3 turns off, substantially no current flows through the fifth and sixth resistors R5, R6, and, consequently, the base input 66 to the fourth transistor Q4 turns low. Therefore, the fourth transistor Q4 turns off. When the fourth transistor Q4 turns off, a logical high appears at the point 70 of the circuit 50. Therefore, a logical high signal is output to the CPU 14 when the Ferro-magnetic teeth on the wheel of the vehicle are not passing the motion sensor 20.

A first capacitor C1 acts as a power capacitor for the circuit 50. The first capacitor C1 is charged as a function of the state of the charging transistor Q_{C}, which functions as a charge control device, and the electrical power at the point 70 in the circuit 50. More specifically, when the charging transistor Q_{C} is on and a logical high signal is present at the point 70, the first capacitor C1 is charged, via the charging transistor Q_{C}, by the electrical power at the point 70. On the other hand, when the charging transistor Q_{C} is off and a logical low signal is present at the point 70, the first capacitor C1 supplies power to the circuit 50. The power supplied to the circuit 50 via the first capacitor C1 keeps power supplied to the circuit 50 during a time while very little power is present at the point 70. Any significant discharge of the first capacitor C1 is minimized because the charging transistor Q_{C} is off.

As discussed above, when the point 70 is a logical high, the Ferro-magnetic teeth on the wheel are not passing the motion sensor 20 and, therefore, a signal less than or equal to the predetermined amplitude is present on the input terminals 54a₁ and 54a₂. Because a base input 72 to the charging transistor Q_{C} is electrically connected to the input terminals 54a₁ and 54a₂, a logical low signal is supplied to the base 72 of the charging transistor Q_{C}. Consequently, the charging transistor Q_{C} turns on, thereby allowing the power at the point 70 of the circuit 50 to charge the first capacitor C1.

When the point 70 is a logical low, the Ferro-magnetic teeth on the wheel are passing the motion sensor 20 and, therefore, a signal greater than the predetermined amplitude is present on the input terminals 54a₁ and 54a₂. Consequently, a logical high signal is supplied to the base 72 of the charging transistor Q_{C}, causing the charging transistor Q_{C} to turn off. As pointed out above, the fourth transistor Q4 is on at a time when a logical low signal is present at the point 70. Therefore, because the charging transistor Q_{C} is off, the first capacitor C1 is substantially prevented from being discharged via the fourth transistor Q4.

A second capacitor C2 and a diode D1 are electrically connected in parallel between the first and second input terminals 54a1 and 54a2, respectively. The second capacitor C2 and the diode D1 act to clip any negative signal input from the input terminals 54a₁ and 54a2.

The first transistor Q1 and first resistor R1 act to compensate for temperature changes and provide better tracking for the circuit 50.

The seventh resistor R7 and the resistor R_{P}, provide a mechanism for testing the circuit 50. More specifically, the resistors R7, R_{P} allow the CPU 14 to sense when a fault condition is present in any one of the wheel speed sensors 16 (e.g., if a motion sensor 20 is not electrically connected to the CPU 14 or the IPU 18), if a short-circuit exists to the ground 56, or if a short-circuit exists to the power source 60, etc.

In a normal state of operation (e.g, when the power source is +5 Volts), the CPU 14 is electrically connected to the point 70. If no open-circuit is present, the voltage that exists at the point 70 is about:

V₁−(l*Rₚ),

where V₁ represents the voltage (e.g., about +5 Volts) of the power source 60 and I represents the current through the resistor R_{P}. While the voltage at the point 70 is still a logical high, the voltage is measurably below V₁. If, on the other hand, an open-circuit exists, the voltage that exists at the point 70 is about V₁ (e g, +5 Volts) and will not be measurably below V₁.

Similarly, when the IPU 18a is outputting a logical low signal to the point 70, the fourth transistor Q4 is turned on. Although the point 70 is electrically connected to the ground if the fourth transistor Q4 is on, the seventh resistor R7 and the saturation voltage of the fourth transistor Q4 cause the voltage at the point 70 to be above the reference voltage of the ground (e.g., 0 Volts). For example, the seventh resistor R7 and the saturation voltage of the fourth transistor Q4 cause the voltage at the point 70 to be about +0.5 Volts when the fourth transistor Q4 is on. If the voltage at the point 70 is considerably less than about +0.5 Volts (e.g., <˜0.25 Volts), it may be concluded that there is a problem with the sensor and/or sensor connections (e.g., a short-circuit to the ground 56 exists).

The CPU 14 receives the signals from the IPU 18a and determines, according to conventional methods, whether the corresponding wheel is slipping. If the wheel is slipping, the CPU 14 applies the braking device 26a to produce an anti-lock braking effect. In this manner, the CPU 14 dynamically controls the braking device 26a as a function of the logical signals output from the IPU 18a Although the preferred embodiment merely illustrates transmitting anti-locking braking signals from the CPU 14 to one of the braking devices 26a, it is to be understood that the CPU 14 controls each of the braking devices 26 independently of each other.

The digital wheel speed signals transmitted between the wheel speed sensor 16 and the CPU 14 are conditioned at the source (i.e., the wheel speed sensor 16 and, therefore, are relatively less susceptible to electromagnetic noise interference than analog signals. Therefore, the anti-lock braking system of the present invention may operate even when the vehicle is traveling at lower speeds (e.g., less than about four (4) mph)

FIG. 3 is a physical layout of the IPU 18a in accordance with a preferred embodiment of the invention. As highlighted in FIG. 3, all five (5) of the transistors Q1, Q2, Q3, Q4, Q_{C} illustrated in FIG. 2 are preferably included on a single integrated circuit chip 80a. In the preferred embodiment, the integrated circuit chip 80 is a CA3096AE. However, other integrated circuit chips are also contemplated. The IPU 18a is preferably composed of high temperature components which have an operating temperature rating of 180 degrees centigrade or more.

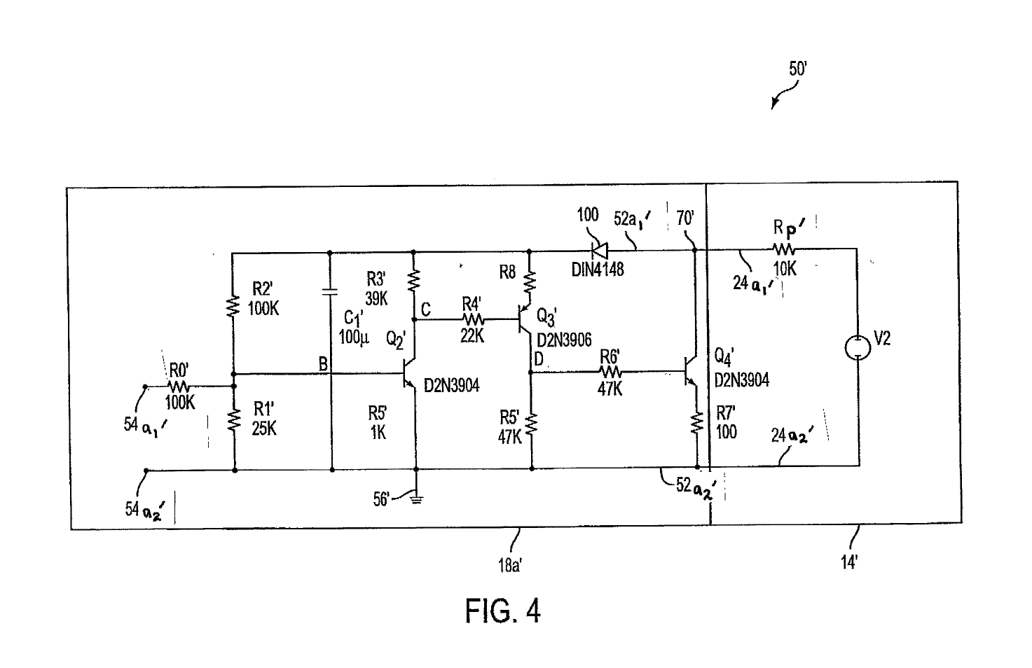

FIG. 4 illustrates a second embodiment of the present invention. For ease of understanding this embodiment of the present invention, like components are designated by like numerals with a primed (′) suffix and new components are designated by new numerals.

In the embodiment shown in FIG. 4, the first capacitor C1′ is charged by the electrical power at the point 70′ via a diode 100 which acts as the charge control device. More specifically, when a logical high signal is present at the point 70′, the first capacitor C1′ is charged, via the diode 100, by the electrical power at the point 70′. On the other hand, when a logical low signal is present at the point 70′, the first capacitor C1′ supplies power to the circuit 50′. The power discharged by the first capacitor C1′ keeps power supplied to the circuit 50′ during a time while very little power is present at the point 70′ of the circuit. Any significant discharge of the first capacitor C1′ is minimized by the diode 100. Resistors R8 and R7′ control the amount of current flowing through the third transistor Q3′. This allows the active sensing embodied to be accomplished via only two (2) wires (i.e., a ground wire 24a₂′ and 52a₂′ and a positive supply wire 24a₁′ and 52a₁′) with the signal from the IPU 18a′ back to the CPU 14′ modulated on the positive supply wire 24a₁′ and 52a₁′.

It is contemplated in alternate embodiments to reduce the value of the first capacitor C₁, which would give more options on the choice of other components for higher-temperature applications.

It is also contemplated in alternate embodiments to include an additional resistor (e.g., about 100 kS) electrically connected between the first and second output terminals 52a₁′ and 52a₂′. Such an additional resistor will help maintain a higher bias current through the resistor Rₚ′ to achieve less than about 5 Volts between the electrically conductive connectors 24a₁′ and 24a₂′.

An advantage of the present invention is that the circuit structure of the IPU is simplified compared with conventional ABS wheel speed data circuits that process analog signals through amplifiers and comparator circuits prior to generate digital signals. In contrast to conventional circuits, the simplified circuit of the present invention allows the use of circuit components that have sufficient heat resistance to be physically integrate within the wheel speed sensor, which is subject to temperatures in excess of 180° C.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An anti-lock braking system, comprising:
a central processing unit (“CPU”), and
a speed sensor including a motion sensor, an integral processing unit (“IPU”), and a housing which surrounds the motion sensor and the IPU;
wherein the motion sensor produces an analog signal as a function of a movement of an object;
wherein the IPU electrically communicates with the CPU and the motion sensor;
wherein the IPU transmits a digital signal to the CPU as a function of the analog signal received from the motion sensor; and
wherein the CPU achieves an anti-lock braking action of the object as a function of the digital signal received from the IPU.

2. The anti-lock braking system as set forth in claim 1, wherein the IPU includes:
first and second inputs electrically communicating with the motion sensor;
first and second outputs electrically communicating with the CPU; and
a plurality of primary switching means set as a function of the analog signal received by the electrical inputs from the motion sensor.

3. The anti-lock braking system as set forth in claim 2, wherein current passes through the plurality of the primary switching means if the analog signal inputs receive from the motion sensor is one of less than and equal to a predetermined amplitude, thereby creating a logical high at the outputs.

4. The anti-lock braking system as set forth in claim 3, wherein the IPU includes:
a charge control device, current passing through the charge control device as a function of the analog signal received from the motion sensor, and
a power capacitor that is one of charged and discharged as a function of whether current is passing through the charge control device, the power capacitor supplying power to the IPU when discharging.

5. The anti-lock braking system as set forth in claim 4, wherein the IPU further includes:
a second capacitor; and
a diode;
wherein the second capacitor and the diode are electrically connected in parallel between the inputs and act to clip negative signal inputs from the inputs.

6. The anti-lock braking system as set forth in claim 5, wherein the IPU further includes:
a resistive means electrically connected in series with one of the primary switching means, wherein the series connected resistive means and one of the primary switching means are connected in parallel across the inputs to provide compensation for temperature changes.

7. The anti-lock braking system as set forth in claim 4, wherein the primary switching means, the charge control device and the power capacitor included on a single circuit chip.

8. The anti-lock braking system as set forth in claim 1, wherein the object is a wheel.

9. The anti-lock braking system as set forth in claim 8, wherein the motion sensor is a magnetic pick-up coil.

10. The anti-lock braking system as set forth in claim 1, further including:
a plurality of resistive means providing a testing mechanism for at least one of the IPU and the motion sensor.

11. The anti-lock braking system as set forth in claim 1, wherein a plurality of additional motion sensors and additional IPU's transmit signals to the CPU corresponding to movements of a plurality of additional respective objects, the CPU transmitting independent braking signals to activate respective braking devices corresponding to the objects for achieving respective anti-lock braking actions.

12. The anti-lock braking system as set forth in claim 1, wherein the IPU is composed of components which function in a high temperature environment which is greater than or equal to 180 degrees centigrade.

13. The anti-lock braking system as set forth in claim 2, wherein the primary switching means are electrically connected in parallel between the outputs.

14. The anti-lock braking system as set forth in claim 4, wherein the charge control device comprises a diode

15. The anti-lock braking system as set forth in claim 4, wherein the charge control device comprises a transistor.

16. A method for activating a braking device for achieving an anti-lock braking action, comprising:
producing an analog signal by a motion sensor as a function of a movement of an object,
transmitting the analog signal from the motion sensor to an integral processing unit (“IPU”) within a speed sensor having a housing which surrounds the motion sensor and the IPU;
producing a digital signal within the speed sensor as a function of the analog signal;
transmitting the digital signal from the speed sensor to a central processing unit (“CPU”); and
transmitting a braking signal from the CPU to activate a braking device for achieving an anti-lock braking action and controlling a velocity of the object as a function of the digital signal received from the speed sensor.

17. The method for activating a braking device for achieving an anti-lock braking action as set forth in claim 16, further including:
setting a plurality of primary switching means as a function of the analog signal transmitted from the motion sensor to the IPU.

18. The method for activating a braking device for achieving an anti-lock braking action as set forth in claim 17, further including:
passing current through a charge control device as a function of the analog signal transmitted from the motion sensor; and
charging a power capacitor as a function of the analog signal transmitted from the motion sensor.

19. The method for activating a braking device for achieving an anti-lock braking action as set forth in claim 18, further including:
clipping negative signal inputs to the IPU with a second capacitor and a diode electrically connected in parallel between inputs to the IPU.

20. The method for activating a braking device for achieving an anti-lock braking action as set forth in claim 16, further including:
testing at least one of the IPU and the motion sensor.

21. A speed sensor, comprising:
a motion sensor;
an integral processing unit (“IPU”);
a housing which surrounds the motion sensor and the IPU;
first and second IPU inputs receiving an analog signal from the motion sensor monitoring a speed of an object, an amplitude of the analog signal being proportional to a speed of the object;
first and second IPU outputs electrically communicating with a central processing unit (“CPU”); and
a plurality of switching devices dynamically set as a function of the amplitude of the analog signal, a logical digital output signal being transmitted from the IPU outputs to the CPU as a function of the analog signal for controlling a braking action of the object

22. The speed sensor as set forth in claim 21, further including:
a charge control device set as a function of the analog signal; and
a power capacitor charged when the charge control device is set to a first mode and discharged when the additional switching means is set to a second mode, the discharge of the power capacitor supplying power to the plurality of switching devices

23. The speed sensor as set forth in claim 21, further including:
a testing device for determining if the motion sensor is operating properly.

24. The speed sensor as set forth in claim 22, wherein the charge control device comprises a diode

25. The speed sensor as set forth in claim 22, wherein the charge control device comprises a transistor.
